(19) United States
(12) Patent Application Publication
(10) Pub. No.: US 2006/0043892 A1
(43) Pub. Date: Mar. 2, 2006

(54) Panel for flat panel display

(75) Inventors: Manabu Yabe, Kyoto (JP); Nobuo Ichinobe, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/197,294

(22) Filed: Aug. 5, 2005

(30) Foreign Application Priority Data
Aug. 25, 2004 (JP) P2004-245676

(51) Int. Cl. H01J 11/02

(52) U.S. Cl. 313/582

(57) ABSTRACT

A panel (1) for a plasma display includes a substrate (2). Linear first ribs (31) each extending in the y direction are arranged in the x direction perpendicular to the y direction on a main surface of the substrate (2) at a predetermined pitch. Linear second ribs (32) each extending in the x direction are arranged in the y direction on the main surface of the substrate (2) at a predetermined pitch. A clearance (4) exists between each of the second ribs (32) and the substrate (2) in a space formed by two adjacent ones of the first ribs (31). Two adjacent cells arranged in the y direction are continuous through the clearance (4). Thus, it is possible to supply a light emitting material, and feed gas necessary for light emission, to each cell using the clearance (4) in a suitable manner in the panel (1).

### BACKGROUND OF THE INVENTION

1. Field of the Invention

The present invention relates to a panel for a flat panel display.

2. Description of the Background Art

For a panel used in a plasma display, ribs on a glass substrate (which will be hereinafter referred to as a “substrate”) are arranged in a pattern of stripes or parallel crosses in most cases. To arrange ribs in a pattern of stripes is advantageous in that manufacture is relatively easy because of simplicity of a structure thereof and that each of cells (light emitting areas) can be exhausted in a relatively short time in supplying gas necessary for light emission to each of the cells, in one aspect. However, to arrange ribs in a pattern of stripes would require provision of a non-light emitting area. Also, a surface area of a phosphor in each of the cells in a case where ribs are arranged in a pattern of stripes is smaller than in a case where ribs are arranged in parallel crosses. As such, a panel including ribs arranged in a grid pattern is more useful for improving a brightness of a plasma display. In view of this, Japanese Patent Application Laid-Open Nos. 2004-55495, 2001-155642, 2001-126621, 2002-134032, and 2002-216620 teach a panel which includes ribs arranged in parallel crosses on a substrate, but allows each of cells to be exhausted in a relatively short time. To this end, in the panel taught in the above-cited references, height of the ribs, each of which extends in one direction, is lower than that of the other ribs, each of which extends in another direction.

On the other hand, sandblasting (which is also called “photolithography”), screen-printing, a light-off process, and the like have conventionally been known as techniques for forming a rib pattern (arrangement of ribs) in a panel for a plasma display. However, the above-cited techniques are complicated and thus probably increase manufacturing costs.

In the foregoing situations, a new technique such as disclosed in Japanese Patent Application Laid-Open No. 2002-184303 has been developed in recent years. According to the new technique, a paste-like patterning material containing a light curing resin is ejected from a nozzle including small outlets to a substrate to form a rib pattern on the substrate, and thereafter, ultraviolet rays are applied to the patterning material to cure the patterning material. This new technique simplifies a process for forming a rib pattern and allows more efficient use of the patterning material, to thereby reduce manufacturing costs for a panel.

In the meantime, a phosphor serving as a light emitting material is supplied to each of cells in a panel for a plasma display, as known. In this regard, it is noted that it is not easy to uniformly supply a phosphor to each of cells in a panel including ribs arranged in a grid pattern. Thus, there has been also a demand for a technique for uniformly supplying a phosphor to each cell without performing a complicated process.

### SUMMARY OF THE INVENTION

The present invention is directed to a panel for a flat panel display, and it is an object of the present invention to provide a panel in which gas necessary for light emission and a light emitting material can be supplied to each cell in a suitable manner.

A panel for a flat panel display according to the present invention comprises: a substrate; a plurality of first ribs each of which is linear and extends in a first direction, which are arranged in a second direction perpendicular to the first direction on a main surface of the substrate; and a plurality of second ribs each of which is linear and extends in the second direction, which are arranged in the first direction on the plurality of first ribs, wherein a clearance exists between each of the plurality of second ribs and the substrate in at least a part of a space formed by two adjacent ones of the plurality of first ribs.

According to the present invention, it is possible to supply a light emitting material to each of cells in a suitable manner through the clearance between each of the plurality of second ribs and the substrate, or to feed gas necessary for light emission to each of cells in a suitable manner through the clearance between each of the plurality of second ribs and the substrate.

Preferably, each of the plurality of first ribs and the plurality of second ribs are formed of a patterning material ejected from outlets.

Also, the plurality of second ribs may be not in contact with the substrate, or each of the plurality of second ribs may be in contact with the substrate in a central region of the space formed by two adjacent ones of the plurality of first ribs. Because of the contact between each of the plurality of second ribs and the substrate, the strength of the plurality of second ribs can be improved.

Further preferably, polishing is performed at respective intersections between the plurality of first ribs and the plurality of second ribs to expose the plurality of first ribs. This increases a contact area between the panel and a different panel which is to be laid on the plurality of second ribs, to thereby improve the strength of the panel upon which the different panel has been laid.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view of a panel for a plasma display;

FIGS. 2 and 3 are longitudinal sectional views of the panel;

FIG. 4 illustrates a structure of a patterning apparatus;

FIGS. 5 and 6 are enlarged views of the vicinity of a nozzle;

FIGS. 7A and 7B are flow charts illustrating a process flow for forming a pattern;

FIG. 8 is a view for explaining ribs formed by sandblasting; and

FIGS. 9 to 12 illustrate other examples of the panel.

### DESCRIPTION OF THE PREFERRED EMBODIMENTS

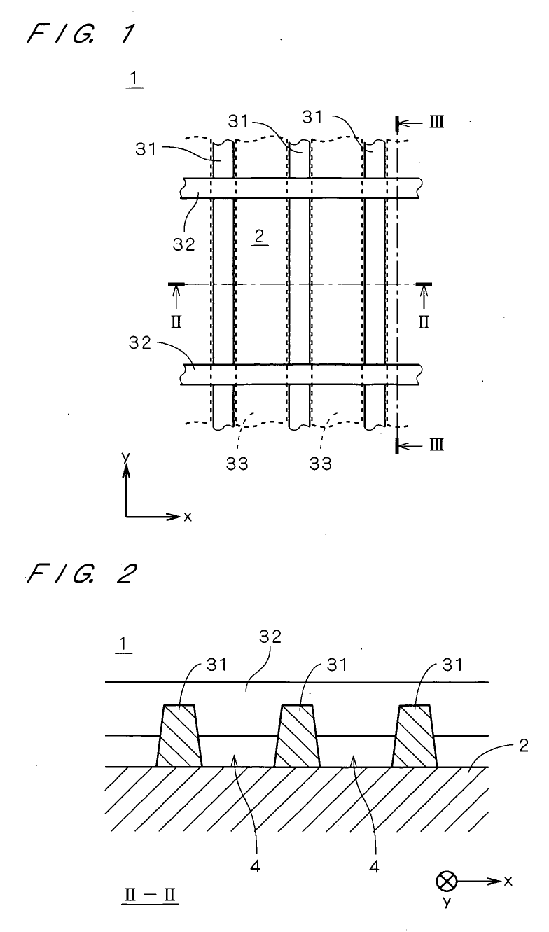

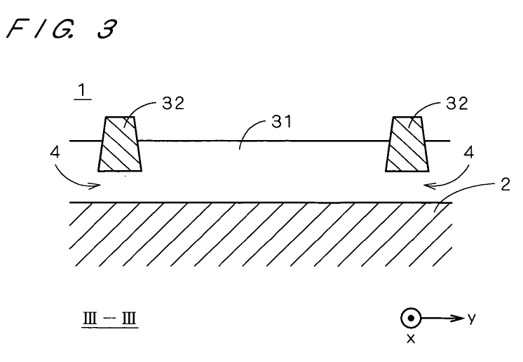

FIG. 1 is a plan view illustrating a part of a panel 1 for a plasma display according to one preferred embodiment of the present invention. FIG. 2 is a longitudinal sectional view of the panel 1, taken along a line II-II in FIG. 1. FIG. 3 is a longitudinal sectional view of the panel 1, taken along a line III-III in FIG. 1. The panel 1 illustrated in FIGS. 1, 2, and 3 is used as a panel (which serves as a rear panel in general) including ribs arranged in parallel crosses (as in a waffle), out of two panels provided opposite to each other in the plasma display.

The panel 1 for the plasma display in FIG. 1 includes a glass substrate 2, and a plurality of first ribs 31 each of which is linear and extends in the y direction shown in FIG. 1 are provided on a main surface of the substrate 2. The plurality of first ribs 31 are arranged at 280-μm pitch, for example, in the x direction shown in FIG. 1 which is perpendicular to the y direction. Also, a plurality of second ribs 32 each of which is linear and extends in the x direction are provided on the first ribs 31 on the substrate 2. The plurality of second ribs 32 are arranged at 840-μm pitch, for example, in the y direction.

As illustrated in FIGS. 2 and 3, each of the first and second ribs 31 and 32 has a profile in the shape of an approximate trapezoid. An average width of the profile is 90 μm, and a height of the profile is 150 μm. The second ribs 32 are located at a predetermined distance from the main surface of the substrate 2 and partially cover the first ribs 31, as illustrated in FIG. 2. Accordingly, a small clearance 4 exists between each of the second ribs 32 and the main surface of the substrate 2 in a space formed by two adjacent ones of the first ribs 31. In more precise expression, a small clearance 4 exist between the main surface and each part of each second rib 32 between each two adjacent first ribs 31.

In assembling the panel 1 into the plasma display, a phosphor of any of colors, red (R), green (G), and blue (B), is supplied to each of regions of the main surface of the substrate 2, which is located between the first ribs 31 (In FIG. 1, the phosphors as supplied are indicated by reference numerals 33 and broken lines). Further, a different substrate serving as a front panel is attached to top surfaces of the second ribs 32 (in other words, surfaces located farthest from the substrate 2) in a later step. As a result, a space between the substrate 2 and the front panel is partitioned into a plurality of discharge regions (i.e., cells) by the ribs 31 and 32 which compose parallel crosses. Two adjacent ones of the cells which are arranged side by side in the y direction are continuous with each other via the clearance 4 between one of the second ribs 32 and the substrate 2, and thus gas such as xenon (Xe) necessary for light emission is fed to each of the cells through the clearance 4, as later described in detail.

In the plasma display, application of a voltage to each of the cells causes plasma discharge, so that ultraviolet rays are produced. Then, the ultraviolet rays are incident upon phosphor layers respectively formed in the cells, to produce invisible light. Additionally, a size of the clearance 4 between each of the second ribs 32 and the substrate 2 is equal to or smaller than a predetermined size, which is small enough to prevent plasma generated in one of the cells from moving to an adjacent cell.

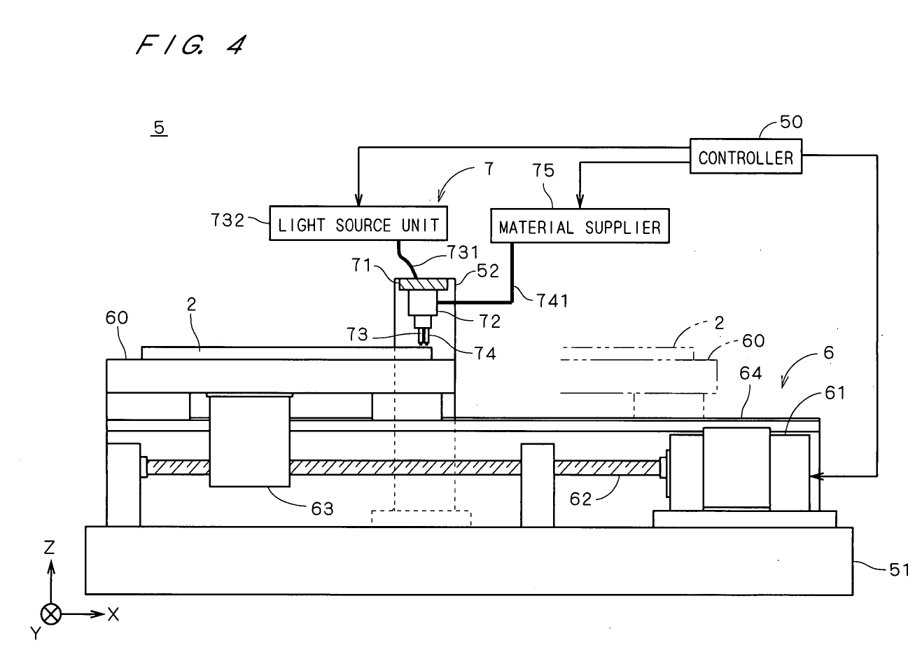

Next, an example of a method for manufacturing the panel 1 will be described. FIG. 4 illustrates a structure of a patterning apparatus 5 employed for manufacturing the panel 1. The patterning apparatus 5 is an apparatus for forming a pattern of a plurality of ribs on the substrate 2.

The patterning apparatus 5 includes a stage moving mechanism 6 provided on a base part 51. Then, a stage 60 for holding the substrate 2 is allowed to move along the main surface of the substrate 2, i.e., in the X direction shown in FIG. 4 by the stage moving mechanism 6. Further, a frame 52 is secured to the base part 51 so as to cross over the stage 60. Moreover, a head 7 is attached to the frame 52.

The stage moving mechanism 6 includes a motor 61 connected with a ball screw 62, and further includes a nut 63 which is secured to the stage 60 and connected to the ball screw 62. Guide rails 64 are fixedly provided above the ball screw 62. With this structure, rotation of the motor 61 causes the stage 60, together with the nut 63, to smoothly move along the guide rails 64, i.e., in the X direction.

The head 7 includes a nozzle 74 for ejecting a paste-like patterning material containing a light curing resin (a resin which cures in response to application of ultraviolet rays in the present preferred embodiment) to the main surface of the (+Z) side of the substrate 2 and a light emitting part 73 for emitting ultraviolet rays toward the ejected patterning material (the main surface of the substrate 2 will be hereinafter also referred to as a “top surface”). The nozzle 74 and the light emitting part 73 are attached and secured to a support 72, to be mounted to the frame 52 with a base 71 interposed therebetween. The nozzle 74 is exchangeable with another nozzle.

The nozzle 74 is connected with a supply pipe 741 for supplying the patterning material through the support 72. The supply pipe 741 is connected to a material supplier 75. The patterning material contains a mixture of a low-melting glass frit as a main ingredient and a light curing resin, which further contains a solvent, an additive, and the like. The light emitting part 73 is connected to a light source unit 732 for producing an ultraviolet ray, with an optical fiber 731 interposed therebetween.

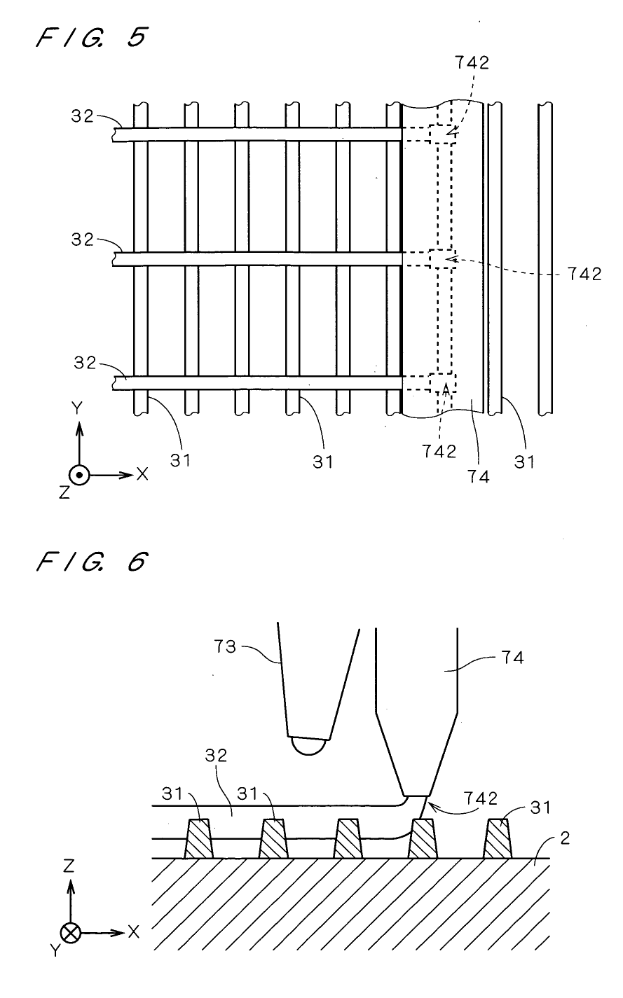

FIG. 5 is an enlarged plan view of the vicinity of the nozzle 74 which is observed in the course of formation of a rib pattern. FIG. 6 is an enlarged view of the vicinity of the nozzle 74 when viewed from the (−Y) side to the (+Y) direction. As illustrated in FIGS. 5 and 6, a plurality of outlets 742 arranged in the Y direction are provided in an end portion of the nozzle 74. Also, the light emitting part 73 illustrated in FIG. 6 is located in the (−X) side relative to the nozzle 74 so that ultraviolet rays emitted from the light emitting part 73 is applied to the patterning material ejected from each of the outlets 742 of the nozzle 74.

Referring back to FIG. 4, the patterning apparatus 5 further includes a controller 50 which is connected with the stage moving mechanism 6, the material supplier 75, and the light source unit 732. Then, the controller 50 controls the foregoing elements such that the plurality of first ribs 31 and the plurality of second ribs 32 are arranged and a rib pattern is formed on the substrate 2.

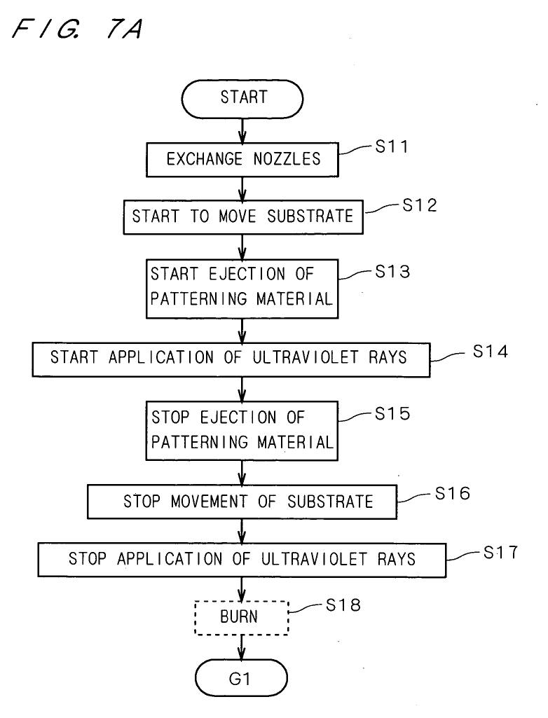

FIGS. 7A and 7B are flow charts illustrating a process flow for forming a rib pattern of the first ribs 31 and the second ribs 32 on the substrate 2. For formation of a rib pattern, first, the nozzle 74 including the outlets 742 which are arranged at 280-μm pitch is attached to the support 72 of the patterning apparatus 5 (step S11). Subsequently, the stage moving mechanism 6 is controlled by the controller 50 illustrated in FIG. 4 such that the substrate 2, together with the stage 60, starts to move in the (−X) direction from a position indicated by double-dashed lines in FIG. 4 (step S12). When the nozzle 74 reaches a starting point for formation of pattern on the substrate 2, ejection of the patterning material from the outlets 742 toward the top surface of the substrate 2 is started (step S13). Then, a shutter (not illustrated) provided in the light source unit 732 is opened, and ultraviolet rays are applied to the patterning material which has just been ejected to the substrate 2, by the light emitting part 73 (see FIG. 6) (step S14). As a result, the plurality of first ribs 31 each of which is linear and extends in the direction of movement of the substrate 2 are arranged in the Y direction at 280-μm pitch, so that a pattern of the first ribs 31 is formed on the substrate 2.

When the outlets 742 of the nozzle 74 reach an end point for formation of pattern on the substrate 2, ejection of the patterning material is stopped (step S15). On the other hand, the substrate 2 continues to move in order to cure a portion of the patterning material which has been ejected in the vicinity of the end point. Thereafter, movement of the stage 60 is stopped (step S16) and also application of ultraviolet rays is stopped, so that formation of the pattern of the first ribs 31 is finished (step S117). As is made clear from the foregoing description, movement of the substrate 2 relative to the nozzle 74, ejection of the patterning material, and application of ultraviolet rays occur in parallel for formation of the pattern.

After formation of the pattern of the first ribs 31 is finished, the substrate 2 is taken out from the patterning apparatus 5 for a while. Thereafter, the first ribs 31 on the substrate 2 are burnt by another apparatus (at a temperature of approximately 500 degrees for 10 seconds, for example) (step S18). As a result, the resin contained in the patterning material is removed and the low-melting glass frit fuses into solid masses.

Then, the stage 60 is moved in the (+X) direction to return back to the initial position, and the nozzle 74 is exchanged with another nozzle including outlets 742 which are arranged at 840-μm pitch (step S21). Also, the substrate 2 is placed on the stage 60 such that each of the first ribs 31 on the substrate 2 extends in the Y direction, by an operator. Subsequently, the substrate 2 moves in the (−X) direction, and ejection of the patterning material and application of ultraviolet rays occur, in the same manner as in formation of the pattern of the first ribs 31 (see FIGS. 5 and 6), so that the plurality of second ribs 32 each of which is linear and extends in the X direction perpendicular to the direction in which each of the first ribs extends are arranged in the Y direction at 840-μm pitch and a pattern of the second ribs 32 is formed, on the main surface of the substrate 2 (steps S22, S23, and S24). Additionally, the patterning material employed in the present preferred embodiment is of a kind that has a poorer wetting property with respect to the patterning material which has been burnt, than that with respect to the patterning material which is not burnt (in other words, which has been preliminarily cured by ultraviolet rays).

When the outlets 742 reach an end point for formation of the pattern, ejection of the patterning material is stopped and also movement of the stage 60 and application of ultraviolet rays are stopped, so that formation of the pattern of the second ribs 32 is finished (steps S25, S26, and S27). For formation of the pattern of the second ribs 32, a patterning material different from that employed for formation of the pattern of the first ribs 31 may be employed. Additionally, a step S28 in the process flow of FIG. 7B is not performed in forming the rib pattern illustrated in FIGS. 1 and 2.

After formation of the pattern of the second ribs 32 is finished, the substrate 2 is taken out from the patterning apparatus 5, and the second ribs 32 on the substrate 2 are burnt by another apparatus in the same manner as the first ribs 31 (step S29). In the foregoing manner, it is possible to easily form ribs in parallel crosses (as in a waffle) which includes the plurality of first ribs 31 and the plurality of second ribs 32 and includes a clearance between each of the plurality of second ribs 32 and the substrate 2 in a space formed by two adjacent ones of the first ribs 31, on the substrate, using the patterning material ejected from the outlets 742. Additionally, the clearance 4 may alternatively exists in at least a part of a space formed by two adjacent ones of the first ribs, as illustrated in FIG. 12 which will be later referred to.

The panel 1 is manufactured by the above-described manufacturing method. Then, the panel 1 is transferred to a different apparatus, where a phosphor serving as a light emitting material is supplied to each of cells (sections) on the substrate 2 which is partitioned by the ribs 31 and 32 in parallel crosses. For example, a phosphor of any of colors, R, G, and B, is ejected to the panel 1 while moving outlets of an apparatus for ejecting the phosphor, relative to the panel 1 in the direction in which each of the first ribs 31 extends. As a result, the phosphor is continuously supplied to a space between two adjacent ones of the first ribs 31. At that time, the phosphor spreads between the first ribs 31 (in other words, between ribs arranged at 280-μm pitch) along the first ribs 31 because of capillary action. However, the viscosity of the phosphor, the respective wetting properties of the phosphor to the first ribs 31 and the second ribs 32, and the like are adjusted so as to prevent the phosphor from spreading between the second ribs 32 (in other words, ribs arranged at 840-μm pitch) along the second ribs 32 (see the panel 1 in FIG. 1). Also, two adjacent ones of the cells which are arranged side by side in the direction in which each of the first ribs 31 extends (i.e., in the y direction in FIG. 1) are continuous with each other by existence of the clearance 4 between each of the second ribs 32 and the substrate 2, which allows uniform supply of the phosphor to each of the cells.

Thereafter, various other processes are performed on the panel 1, and then a different glass substrate serving as a front panel is attached to the substrate 2 with the ribs 31 and 32 interposed therebetween. For attachment of the front panel, first, a layer of glass having a low softening point which serves as an adhesive is formed on parts of the ribs of the substrate 2 which are to be in contact with the front panel (i.e., top surfaces of the second ribs 32) and parts of the front panel which are to be in contact with the top surfaces of the second ribs 32. Subsequently, the panel 1 and the front panel are aligned with each other and preparatively secured to each other, and then are burnt to be firmly secured to each other. After the front panel is attached to the panel 1, air is efficiently let out from each of the cells through the clearance 4 between each of the second ribs 32 and the substrate 2, and gas necessary for light emission is fed (in other words, air in each of the cells is replaced with gas for light emission). Then, respective peripheries of the two panels are sealed to each other. In this manner, a principal structure of the plasma display including the panel 1 is completed.

As described above, the clearance 4 exists between each of the plurality of second ribs 32 and the substrate 2 in a space formed by two adjacent ones of the first ribs 31 in the panel 1 illustrated in FIG. 1. The existence of the clearance 4 between each of the second ribs 32 and the substrate 2 allows a phosphor used for light emission to spread with a uniform thickness between two adjacent ones of the cells which are arranged side by side in the direction in which each of the first ribs 31 extends, even if ejection of the phosphor is interrupted for a moment in the course of supply of the phosphor. Thus, it is possible to supply the phosphor to each of the cells in a suitable manner. Also, it is possible to feed gas necessary for light emission into each of the cells in a suitable manner through the clearance 4.

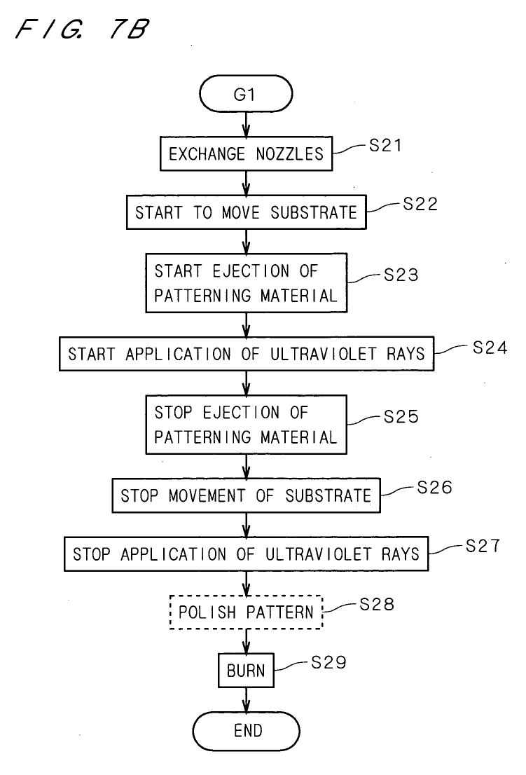

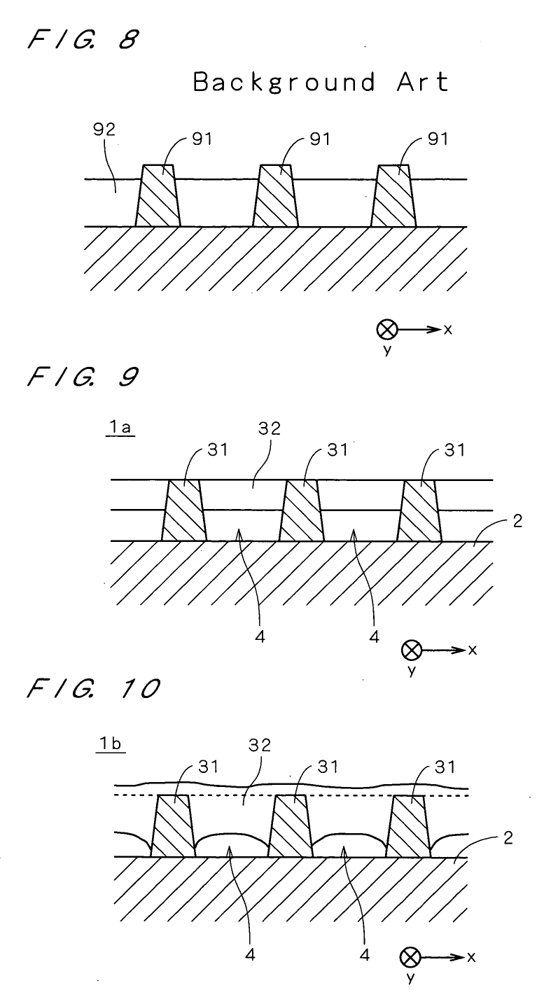

In a case where sandblasting is employed, and first ribs 91 and the second ribs 92 which are different in height from each other are provided as illustrated in FIG. 8 in order to facilitate exhaustion, etching must be performed twice, which complicates a procedure. Further, it is generally known that employment of sandblasting reduces the efficiency in use of a material for forming ribs, to increase manufacturing costs of panel. In contrast thereto, since each of the first ribs 31 and the second ribs 32 is formed of the patterning material ejected from the outlets 742 in the panel 1 illustrated in FIG. 1, it is possible to easily form the clearance 4 between each of the second ribs 32 and the substrate and save a material to thereby reduce manufacturing costs of panel.

FIG. 9 illustrates a second example of a panel for a plasma display. In a panel 1a illustrated in FIG. 9, a top surface of each of first ribs 31 and a top surface of each of second ribs 32 are substantially flush with each other. In manufacturing the panel 1a, polishing is additionally performed at intersections between the first ribs 31 and the second ribs 32 to expose the first ribs 31 (step S28 in FIG. 7B) after formation of the pattern of the second ribs 32 is finished in the above-described method for manufacturing the panel. Then, after the first ribs 31 are exposed, the second ribs 32 are burnt (step S29). As a result, a different substrate (front panel) laid on the second ribs 32 is in contact with not only the respective top surfaces of the second ribs 32 but also the respective top surfaces of the first ribs 31. In other words, the different substrate is contact with a surface of parallel crosses formed by the respective top surfaces of the first and second ribs, so that a contact area between the different substrate and the panel 1a is larger than that between the different substrate and the panel 1. This improves the strength of the panel 1a upon which the different substrate has been laid.

FIG. 10 illustrates a third example of a panel. A panel 1b illustrated in FIG. 10 is manufactured by making alteration in the above-described method for manufacturing a panel. Specifically, to manufacture the panel 1b, the pattern of the second ribs 32 is formed before the first ribs 31 are burnt, and thereafter, the first ribs 31 and the second ribs 32 are burnt at the same time. Thus, the step S18 in FIG. 7A is not performed. As a result, a wetting property of the patterning material for the second ribs 32 with respect to the pattern of the first ribs 31 is improved in forming the pattern of the second ribs 32, so that a top portion of the clearance 4 between each of the second ribs 32 and the substrate 2 in a space formed by two adjacent ones of the first ribs 31 is arched as illustrated in FIG. 10. Accordingly, adhesion of the second ribs 32 to the first ribs 31 is improved, to thereby enhance the strength of the second ribs 32. Additionally, a wetting property of the patterning material for the second ribs 32 with respect to the first ribs 31 can be improved even after the first ribs 31 are burnt, by performing some surface treatment on the first ribs 31, such as application of a mixture of a light curing resin and a predetermined solvent to the burnt first ribs 31.

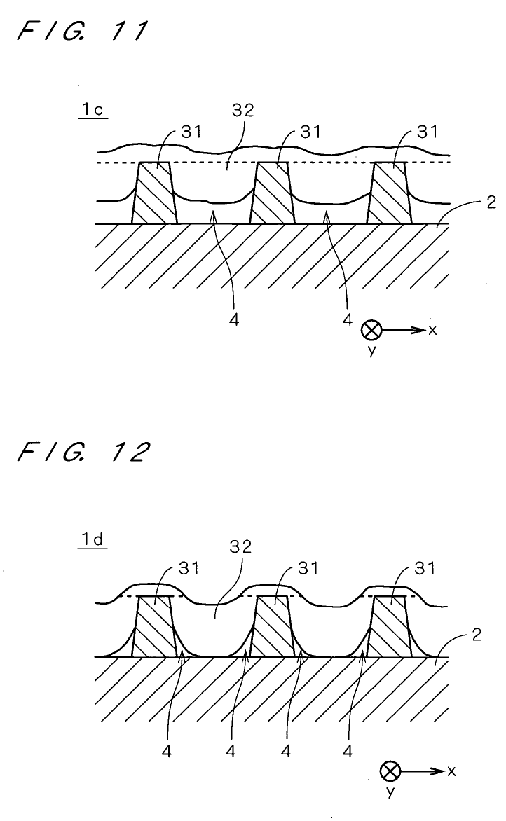

FIG. 11 illustrates a fourth example of a panel. A panel 1c illustrated in FIG. 11 is manufactured by reducing the viscosity of the patterning material for the second ribs 32 as compared to that in manufacturing the panel 1 illustrated in FIG. 1, increasing a time period between ejection of the patterning material and application of ultraviolet rays as compared to that in manufacturing the panel 1 illustrated in FIG. 1, or performing some other processes. As a result, each of the second ribs 32 expands downward, i.e., toward the substrate 2, so that a height of the clearance 4 can be reduced as needed. It is additionally noted that in FIGS. 10 and 11, the respective top surfaces of the second ribs 32 in a case where polishing is performed are indicated by broken lines. Similarly to the panel 1a, to perform polishing provides for improvement in the strength of the panel 1b or the panel 1c upon which a front panel has been laid.

In each of the panel 1, 1a, 1b, and 1c illustrated in FIGS. 1, 9, 10 and 11, respectively, the second ribs 32 are not in contact with the substrate 2. This makes it possible to efficiently supply a light emitting material, or efficiently feed gas necessary for light emission, to each of the cells. However, the second ribs 32 may be in contact with the substrate 2 when needed in view of a design of a panel. For example, by further reducing the viscosity of the patterning material for the second ribs 32 as compared to that in manufacturing the panel 1c in FIG. 11, or further increasing a time period between ejection of the patterning material and application of ultraviolet rays as compared to that in manufacturing the panel 1c in FIG. 11, it is possible to manufacture a panel 1d in which each of the second ribs 32 further expands downward so that each of the second ribs 32 (i.e., each part of each second rib 32 between two adjacent first ribs 31) is contact with the substrate 2 in a central region of a space formed by two adjacent ones of the first ribs 31, as illustrated in FIG. 12. In the panel 1d, the clearance 4 between each of the second ribs 32 and the substrate 2 exists only in a region very close to each of the first ribs 31. With such a structure, gas necessary for light emission or a light emitting material can be supplied to each of the cells in a suitable manner through the clearances 4, and also, the strength of the second ribs 32 can be improved because of the contact between each of the second ribs 32 and the substrate 2. Additionally, polishing may be performed also in manufacturing the panel 1d. The respective top surfaces of the second ribs 32 of the panel 1d in a case where polishing is performed are indicated by broken lines in FIG. 12. In this case, a height of each of the second ribs 32 is standardized at a height thereof between the first ribs 31 in the panel 1d, to thereby further improve the strength of the panel 1d.

As described above, as long as the clearance 4 exists between each of the second ribs 32 and the substrate 2 in at least a part of a space formed by two adjacent ones of the first ribs 31, a shape of the clearance 4 (more specifically, how many areas the first ribs 31 and the second ribs 32 are in contact with each other, or how deep each of the second ribs 32 expands downward between the first ribs 31) in the panel manufactured by the processes illustrated in FIGS. 7A and 7B can be varied. The shape of the clearance 4 can be adjusted to some degree by adjusting the viscosity of the patterning material for the second ribs 32, the wetting property of the patterning material for the second ribs 32 with respect to the first ribs 31, illuminance of ultraviolet rays, a time period between ejection of the patterning material and application of ultraviolet rays to the patterning material, or the like, changing a kind of the patterning material for the second ribs 32, or performing some other processes.

Further, in each of the above-described panels, an arrangement pitch of the plurality of first ribs 31 is smaller than that of the plurality of second ribs 32 in order to ensure a predetermined strength of the second ribs 32. However, the arrangement pitch of the first ribs 31 may be 840 μm and the arrangement pitch of the second ribs 32 may be 280 μm, for example. In a case where the foregoing pitches are employed, a phosphor is supplied between two adjacent ones of the second ribs 32. As such, the wetting property of the phosphor with respect to the substrate 2 (more precisely, a dielectric layer formed on a surface of the substrate 2) is reduced and the phosphor is supplied so as to cause the phosphor to run downward along a side face of each of the second ribs 32 and extend over the substrate 2. As a result, after the phosphor is burnt, the phosphor remains on the side face of each of the second ribs 32 and the top surface of the substrate 2.

Hereinbefore, the preferred embodiments of the present invention have been described. However, the present invention is not limited to the above-described preferred embodiments, and various modifications are possible.

The curing resin contained in the patterning material is not necessarily required to cure in response to application of ultraviolet rays. Alternatively, a thermosetting resin may be employed, for example. Also, the patterning material may contain fine particles other than a glass frit.

The above-described method for manufacturing a panel is applicable to manufacture of other types of flat panel displays such as an organic electroluminescence (EL) display and a liquid crystal display. When applied to those types of flat panel displays, the second ribs 32 are formed such that respective bottom surfaces of the second ribs 32 are substantially flush with the respective top surfaces of the first ribs 31 so that the clearance 4 between each of the second ribs 32 and the substrate 2 can be increased in size, by increasing the viscosity of the patterning material used for forming the second ribs 32, or performing some other processes. Also, the substrate 2 is not limited to a glass substrate, and may be another type of substrate.

While the invention has been shown and described in detail, the foregoing description is in all aspects illustrative and not restrictive. It is therefore understood that numerous modifications and variations can be devised without departing from the scope of the invention.

This application claims priority benefit under 35 U.S.C. Section 119 of Japanese Patent Application No. 2004-245676 filed in the Japan Patent Office on Aug. 25, 2004, the entire disclosure of which is incorporated herein by reference.

What is claimed is:

1. A panel for a flat panel display comprising
a substrate;
a plurality of first ribs each of which is linear and extends in a first direction, said plurality of first ribs being arranged in a second direction perpendicular to said first direction on a main surface of said substrate; and
a plurality of second ribs each of which is linear and extends in said second direction, said plurality of second ribs being arranged in said first direction on said plurality of first ribs, wherein
a clearance exists between each of said plurality of second ribs and said substrate in at least a part of a space formed by two adjacent ones of said plurality of first ribs.

2. The panel for a flat panel display according to claim 1, wherein
each of said plurality of first ribs and said plurality of second ribs are formed of a patterning material ejected from outlets.

3. The panel for a flat panel display according to claim 1, wherein
said plurality of second ribs are not in contact with said substrate.

4. The panel for a flat panel display according to claim 1, wherein
each of said plurality of second ribs is in contact with said substrate in a central region of said space formed by two adjacent ones of said plurality of first ribs.

5. The panel for a flat panel display according to claim 1, wherein
polishing is performed at respective intersections between said plurality of first ribs and said plurality of second ribs to expose said plurality of first ribs.
